(19) United States
(12) Patent Application Publication
(10) Pub. No.: US 2012/0148074 A1
(43) Pub. Date: Jun. 14, 2012

(54) Electrostatic Loudspeaker System

(76) Inventors: Gaston Bastiaens, Westerlo (BE); Ronald Buining, Zeist (NL)

(21) Appl. No.: 13/273,931

(22) Filed: Oct. 14, 2011

Related U.S. Application Data
(60) Provisional application No. 61/393,318, filed on Oct. 14, 2010.

(51) Int. Cl. H04R 19/02

(52) U.S. Cl. 381/191

(57) ABSTRACT

An electrostatic loudspeaker (ESL) system includes a damping screen adjacent an outside surface of at least one of its stators to reduce distortion of acoustic output rendered by the loudspeaker's diaphragm, including effects of resonance of the diaphragm. A resilient excursion limiter placed adjacent an inside surface of at least one of the stators prevents contact of the diaphragm with the stator. A conductive portion of the diaphragm is printed with a conductive ink layer that includes conductive nanofibers. The loudspeaker system includes a dipole-radiating ESL element, an unbaffled or partially baffled dynamic loudspeaker and a baffled monopole-radiating dynamic loudspeaker (subwoofer), all essentially co-planar. The unbaffled or partially baffled dynamic loudspeaker provides a smooth transition in sound between the dipole-radiating ESL element and the monopole-radiating subwoofer. The ESL system includes two or more invertedly-driven ESL elements of different sizes, each element handling a different range of frequencies.

### CROSS REFERENCE TO RELATED APPLICATIONS

This application claims the benefit of U.S. Provisional Patent Application No. 61/393,318, filed Oct. 14, 2010, titled “Electrostatic Loudspeaker System,” the entire contents of which are hereby incorporated by reference herein, for all purposes.

### TECHNICAL FIELD

The present invention relates to an electrostatic loudspeaker system and, more particularly, to an electrostatic loudspeaker system having a damping screen on an external surface of a stator; an electrostatic loudspeaker system including a mechanical soft clipper to limit diaphragm excursion; an electrostatic loudspeaker system including an electrical conductive nanothread-coated diaphragm; and an electrostatic loudspeaker system having a combination of two dipole and one monopole radiators in each speaker system.

### BACKGROUND ART

An electrostatic loudspeaker (ESL) is a loudspeaker in which sound is generated by vibrating a taut membrane (a “diaphragm”). The diaphragm is urged to vibrate by a varying high-voltage electrostatic field, which varies according to an input audio signal. The diaphragm usually consisting of a thin flat plastic sheet coated with a conductive material, such as graphite or a conductive polymer, suspended between two electrically conductive grids (“stators”), with a small air gap between the diaphragm and each stator. An electrostatic field is established between the conductive portion of the diaphragm and each stator. The electrostatic fields therefore apply forces on the diaphragm, alternatingly urging the diaphragm toward one stator and away from the other stator.

The stators should generate as uniform an electric field as possible, while still allowing for sound to pass through. A suitable stator typically includes a perforated metal sheet, a frame with tensioned wires or wire rods.

The diaphragm is usually made from a polyester film, typically having a thickness of about 2-20 μm, with exceptional mechanical properties, such as PET (polyethylene terephthalate) film. By means of the conductive coating and an external high voltage supply, in so-called “normal” drive, the diaphragm is held at a DC potential of several kilovolts, with respect to the stators. The stators are driven by the audio signal. The front and rear stators are driven in antiphase. As a result, a uniform electrostatic field proportional to the audio signal is produced between the stators and diaphragm. This causes forces to be exerted on the diaphragm, and the resulting movement of the diaphragm drives air on either side of the diaphragm.

For low distortion operation, the diaphragm should operate with a uniform constant charge on its surface, rather than with a uniform constant voltage. A uniform constant charge is desirable, so the electrostatic force is at least approximately equal over the entire surface of the diaphragm. If the electrostatic force were significantly greater on one portion of the diaphragm than on other portions, the diaphragm would be physically distorted, rather than moving smoothly with each oscillation of the audio signal.

One method used to evenly distribute the charge across the conductive surface of the diaphragm is to select and apply the conductive coating so as to provide a relatively high surface electrical resistance. If the resistance were low, charges would migrate and quickly accumulate in one or more portions of the diaphragm closest to the stator, leading to more electrostatic attraction/repulsion on those portions, thereby causing distortion. A high electrical resistance slows the migration of charges across the surface, relative to the frequency with which the diaphragm vibrates, so excess charge does not accumulate on one or more portions of the diaphragm.

Some ESLs produced by Dayton Wright, Canada, include very high conductive coating resistances, on the order of 1,000 megohms per square, which produce charge times of several days. This high surface resistivity increased the charge migration time to a few seconds, reducing the low frequency distortion and producing base response down to about 40 Hz.

Typical conductive coatings include graphite or conductive polymer particles on the order of 0.05 to 1.0 μm in diameter. In some ESLs, a high value resistor is placed in series with the conductive portion of the diaphragm to limit the rate at which charges migrate onto the diaphragm.

In most electrostatic loudspeakers, the diaphragm is driven by two stators, one on each side of the diaphragm, because the electrostatic force exerted on the diaphragm by a single stator would be unacceptably non-linear, thus causing harmonic distortion. Using stators on both sides of the diaphragm cancels out the voltage-dependent part of the non-linearity, but leaves a charge (attractive force) dependent part. The result is a reduction of harmonic distortion.

Standard ESL drive methodology involves applying a high voltage bias to the high resistance coating on the diaphragm and applying the audio signal from a center-tapped audio transformer to the low resistance stators. However, in one recent design from Transparent Sound Technology, the diaphragm is driven with the audio signal, with a static charge placed on the stators. Such speakers use an inverted audio drive to the panels, compared to conventional electrostatic speakers. In the Transparent Sound Technology design, the stators are high resistance components, and a complementary (meaning a plus and a minus high voltage bias supply) is connected to opposite stators. The diaphragm is then driven by the audio transformer.

An ESL is, in effect a capacitor created by the diaphragm and the stators, and current is only needed to charge the capacitor. This type of speaker is, therefore, a high-impedance device. In contrast, a modern electrodynamic (“dynamic”) cone loudspeaker is a low-impedance device, with higher current requirements. As a result, impedance matching is typically necessary in order to use an ESL with a normal low-impedance output amplifier. Most often a transformer is used to achieve this matching. Construction of this transformer is critical, as it must provide a constant (often high) transformation ratio over the entire audible frequency range (i.e., a large bandwidth) and avoid distortion. The transformer is almost always specific to a particular electrostatic speaker. Acoustat UK Ltd has built a commercial “transformer-less” electrostatic loudspeaker. In this design, the audio signal is applied directly to the stators from a built-in high-voltage vacuum tube amplifier (vacuum tubes are also high impedance devices), without use of a step-up transformer.

Advantages of electrostatic loudspeakers include: levels of distortion one to two orders of magnitude lower than conventional cone drivers in a box; the extremely light weight of the diaphragm, which is driven across its whole surface; and exemplary frequency response (both in amplitude and phase), because the principle of generating force and pressure involves less resonance than more common electrodynamic drivers. Musical “transparency” can be better than in electrodynamic speakers, because the radiating surface of an ESL has much less mass than most other drivers and is, therefore, far less capable of storing energy to be released later. For example, typical dynamic speaker drivers can have moving masses of tens or hundreds of grams, whereas an electrostatic diaphragm typically weighs only about a few milligrams, i.e., several times less than the very lightest of electrodynamic tweeters. The concomitant air load, often insignificant in dynamic speakers, is usually tens of grams in an ESL. The large coupling surface of an ESL diaphragm contributes to damping of resonance buildup by the air itself to a significant, though not complete, degree. ESL systems can also be executed as full-range designs, lacking the usual crossover filters and enclosures that could color or distort the sound.

Since many electrostatic speakers are tall and thin, without enclosures, they act as vertical dipole line sources. This makes for rather different acoustic behavior in rooms, compared to conventional electrodynamic loudspeakers. Generally speaking, a large-panel dipole radiator is more demanding of a proper physical placement within a room than a conventional box speaker. However, once properly positioned, the ESL is less likely to excite bad-sounding room resonances, and its direct-to-reflected sound ratio is often higher by some 4-5 db than conventional speakers. This, in turn, leads to more accurate stereo reproduction of recordings that contain proper stereo information and venue ambience. Planar (flat) drivers tend to be very directional, giving them good imaging qualities, on the condition that they have been carefully placed relative to the listener and the sound-reflecting surfaces in the room. Curved panels have been built, making the placement requirements a bit less stringent, but sacrificing imaging precision somewhat.

One common disadvantages of ELSs is a lack of bass response, due to phase cancellation from the lack of enclosure. For example, for dipole radiators, the bass roll-off 3 db point occurs when the narrowest panel dimension equals a quarter wavelength of the radiated frequency. For example, for an ESL that is 0.66 meters wide, this occurs at about 129 Hz, which is comparable to many box speakers. (The speed of sound assumed to be 343 m/sec.) Another common disadvantage of ELSs is the difficult physical challenge of reproducing low frequencies with a taut vibrating diaphragm with little excursion amplitude. However, as most ESL diaphragms have a very large surface area compared to cone drivers, only small amplitude excursions are required to generate relatively large amounts of acoustic energy. Yet another common disadvantage of ELSs is their sensitivity to ambient humidity levels.

While bass is typically lacking quantitatively (due to lower distortion than cone drivers), it can be of better quality (“tighter” and without “booming”) than that of electrodynamic (cone) systems. Phase cancellation can be somewhat compensated for by electronic equalization, such as by a so-called “shelving” circuit that boosts the region inside the audio band where the generated sound pressure drops because of phase cancellation. Nevertheless, maximum bass levels are ultimately limited by the diaphragm's maximum permissible excursion before it comes too close to the high-voltage stators, which may produce electrical arcing and burn holes through the diaphragm. Recent, technically more advanced solutions for the perceived lack of bass include the use of large, curved panels (such as in systems from Sound Lab and MartinLogan, Ltd), electrostatic subwoofer panels (such as in systems from Audiostatic Holland and Quad Electroacoustics Ltd.) and long-throw electrostatic elements allowing large diaphragm excursions (such as in systems from Audiostatic Holland). In some cases, a higher transformation ratio is used to step-up base (about 20-80 Hz) response over that of mid-tone and treble response.

This relative lack of loud bass is often remedied with a hybrid design using a dynamic loudspeaker, e.g., a subwoofer, to handle lower frequencies, and an electrostatic diaphragm handling middle and high frequencies. Many practitioners feel that the best low frequency units for hybrid systems are cone drivers mounted on open baffles as dipoles transmission line woofers or horns, since they possess roughly the same qualities (at least in the bass) as electrostatic speakers, i.e., good transient response, little box coloration, and (ideally) flat frequency response. However, there are often problems with integrating such a woofer with an electrostatic speaker, because most ESLs are line sources, whereas most dynamic loudspeakers behave as point sources. The sound pressure level of a line source decreases by 3 dB for each doubling of distance. A cone speaker's sound pressure level, on the other hand, decreases by 6 dB for each doubling of distance. This difference can be overcome by the theoretically more elegant solution of using conventional cone woofer(s) in an open baffle, or a push-pull arrangement, which produces a bipolar radiation pattern similar to that of the electrostatic membrane. This is still subject to phase cancellation, but cone woofers can be driven to far higher levels due to their longer excursions, thus making equalization to a flat response easier, and they add distortion thereby increasing the area (and therefore the power) under the frequency response graph, making the total low frequency energy higher, but the fidelity to the signal lower.

The directionality of ESLs can also be a disadvantage, in that it means the “sweet spot,” i.e., where proper stereo imaging can be heard, is relatively small, limiting the number of people who can simultaneously fully enjoy the advantages of the speakers.

Because of their tendency to attract dust, insects, conductive particles and moisture, electrostatic speaker diaphragms gradually deteriorate and need periodic replacement. They also need protection measures to physically isolate their high voltage parts from accidental contact with humans and pets.

Electrostatic loudspeakers enjoy some popularity among do-it-yourself (DIY) loudspeaker builders, at least in part because they are one of the few types of speakers in which the transducers themselves can be built from scratch by amateurs. A widely-read resource by ESL enthusiasts is “The Electrostatic Loudspeaker Design Cookbook” (ISBN 978-1-882580-00-2) by notable ESL specialist Roger Sanders. Other references include “The theory of electrostatic forces in a thin electret (MEMS) speaker,” by Eino Jakku, Taisto Tinttunen and Terho Kutilainen, proceedings IMAPS Nordic 2008 Helsingor, September 14-16.

Despite advances in electrostatic loudspeaker technology, difficulties remain in the design and manufacture of such systems. For example, although ESLs typically exhibit much lower distortion than dynamic loudspeakers, some resonance of the diaphragm and distortion in the produced acoustic signal is still present. Care must be taken in the design and operation of an ESL to prevent the conductive portion of the diaphragm from coming too close to, or into contact with, the inside of a stator, otherwise electrical arcing and clipping of the acoustic signal may result. The fidelity of the acoustic signal depends in part on how faithfully the diaphragm responds to the electrical audio signal, which is influenced by the mass, thickness and tension of the diaphragm, more massive diaphragms requiring more electrostatic force to produce equivalent amounts of acceleration (F=ma). Typically, larger diaphragm excursions are needed to reproduce lower frequencies at comparable sound pressure levels. Thus, the diaphragm must be stretched more, which requires more force. In addition, as noted, most ESLs do not have adequate low-frequency response, and combining ESLs with dynamic subwoofers produces less than ideal results, particularly in the transition frequencies between the two types of drivers.

### SUMMARY OF EMBODIMENTS

An embodiment of the present invention provides an improved electrostatic speaker of the type having a pair of stators and a diaphragm disposed between the stators. The speaker renders, into an acoustic output, an electrical audio input coupled to the speaker. The improvement includes a damping screen placed adjacent an outside surface of least one of the stators. The improved speaker is configured so that the damping screen reduces distortion of the acoustic output rendered by the diaphragm. The distortion includes effects of resonance of the diaphragm.

The damping screen may include a fabric selected to provide effective damping of resonance of the diaphragm at a fundamental frequency. Optionally or alternatively, the improved speaker may include a damping tape placed on a central portion of the damping screen. The damping tape provides further damping of the diaphragm. In some embodiments, the area of the damping tape may be about 15% of the area of the diaphragm. In some embodiments, the longest dimension of damping tape may be aligned with the longest dimension of the diaphragm. The fabric may be woven from threads. Optionally or alternatively, the fabric may include a perforated sheet of material. The threads may include plastic. The threads may include polyester. The threads may be spaced at a density of about 54 threads per cm and have a diameter of about 64 microns. The threads may include metal. The fabric may have a porosity of between 10 and 50%. Optionally or alternatively, the fabric may have a porosity of between 15% and 40%. Optionally or alternatively, the fabric may have a porosity between 20% and 35%. The screen may be affixed by glue to the outside surface of the at least one of the stators.

Another embodiment of the present invention provides an improved electrostatic speaker of the type having a pair of stators and a diaphragm disposed between the stators. The improved speaker includes a resilient excursion limiter placed adjacent an inside surface of at least one of the stators. The resilient excursion limiter is configured so as to prevent contact of the diaphragm with the at least one of the stators.

The excursion limiter may be made of a non-woven fiber, a woven material or foam.

Yet another embodiment of the present invention provides an improved electrostatic speaker of the type having a pair of stators and a diaphragm disposed between the stators. The speaker renders, into an acoustic output, an acoustic signal based on an electrical audio input coupled to the speaker. The improved speaker includes a conductive ink layer disposed on the diaphragm. The conductive ink including conductive nanofibers.

The conductive ink may provide a resistance of between approximately 50 and 100 kilo-ohms per square. The nanofibers may include a first dimension that is less than approximately 50 nm. The nanofibers may include a first dimension that is approximately 10 nm.

An embodiment of the present invention provides a speaker system that includes an electrostatic speaker, a first dynamic speaker and a second dynamic speaker. All the speakers are mounted in an assembly, wherein they have front-facing acoustic radiating openings that are approximately co-planar. The first dynamic speaker is enclosed so that substantially all of its acoustic output exits from the enclosure through the speaker's front-facing opening. The first dynamic speaker is powered through a first cross-over network to receive audio input in a sub-woofer range below a first cut-off frequency. The second dynamic speaker is mounted so that it provides substantial acoustic output both through the speaker's front-facing opening and through a rear-facing opening. The second dynamic speaker is powered through second cross-over network to receive audio input in a woofer range above the first cut-off frequency and below a second cut-off frequency. The electrostatic speaker is powered through a third cross-over network to receive audio input above the second cut-off frequency.

The first cut-off frequency may be about 70 Hz, and the second cut-off frequency may be about 250 Hz. The first and second dynamic speakers may be mounted in the assembly such that a radiation pattern of the first dynamic speaker overlaps with a radiation pattern of the second dynamic speaker. The overlap between the first and second dynamic drivers forms a cardioid radiation pattern.

An embodiment of the present invention provides an electrostatic loudspeaker system that includes a first electrostatic loudspeaker element having a first pair of stators and a first diaphragm disposed between the first stators. The first diaphragm has a first area. The first electrostatic loudspeaker element is configured for coupling to a first inverted electrostatic loudspeaker driver circuit to receive audio signals above a first predetermined cross-over frequency. The electrostatic loudspeaker system also includes a second electrostatic loudspeaker element having a second pair of stators and a second diaphragm disposed between the second stators. The second diaphragm has a second area greater than the first area of the first diaphragm. The second electrostatic loudspeaker element is configured for coupling to a second inverted electrostatic loudspeaker driver circuit, distinct from the first inverted electrostatic loudspeaker driver circuit, to receive audio signals below the first predetermined cross-over frequency. The first and second electrostatic loudspeaker elements are mounted in an assembly so as to be approximately co-planar with and adjacent each other.

Optionally, the electrostatic loudspeaker system may include a third electrostatic loudspeaker element having a third pair of stators and a third diaphragm disposed between the third stators. The third diaphragm has a third area greater than the second area of the second diaphragm. The third electrostatic loudspeaker element is configured for coupling to a third inverted electrostatic loudspeaker driver circuit, distinct from the first and second inverted electrostatic loudspeaker driver circuits, to receive audio signals below a second predetermined cross-over frequency lower than the first predetermined cross-over frequency. The third electrostatic loudspeaker elements is mounted in the assembly so as to be approximately co-planar with the first and second electrostatic loudspeaker elements and adjacent at least one of the first and second electrostatic loudspeaker elements.

### BRIEF DESCRIPTION OF THE DRAWINGS

The invention will be more fully understood by referring to the following Detailed Description of Specific Embodiments in conjunction with the Drawings, of which:

FIG. 1 is a schematic illustration of a portion of a woven damping screen, according to an embodiment of the present invention;

FIG. 2 is a schematic illustration of a portion of a perforated damping screen, according to an embodiment of the present invention;

FIG. 3 is a cross-sectional schematic illustration of an electrostatic loudspeaker having a damping screen directly attached to a back side stator thereof, according to an embodiment of the present invention;

FIG. 4 is a cross-sectional schematic illustration of an electrostatic loudspeaker having a first damping screen directly on a back side stator thereof and a second damping screen directly on a front side stator thereof, according to an embodiment of the present invention;

FIG. 5 is a cross-sectional schematic illustration of an electrostatic loudspeaker having a damping screen spaced apart from a back side stator thereof, according to an embodiment of the present invention;

FIG. 6 is a cross-sectional schematic illustration of an electrostatic loudspeaker having a damping screen spaced apart from a back side stator thereof, according to another embodiment of the present invention;

FIG. 7 is a cross-sectional schematic illustration of an electrostatic loudspeaker having a damping screen spaced apart from a back side stator thereof, according to yet another embodiment of the present invention;

FIG. 8 is a schematic illustration showing placement of damping tape over portions of damping screens of an electrostatic loudspeaker having three diaphragms (or a single diaphragm partitioned into three sections), according to an embodiment of the present invention;

FIG. 9 is a schematic illustration showing placement of damping tape over portions of damping screens of an electrostatic loudspeaker having more than three diaphragms (or a single diaphragm partitioned into more than three sections), according to an embodiment of the present invention;

FIG. 10 is a cross-sectional schematic illustration of an electrostatic loudspeaker having soft clipping layers on the inside surfaces of the stators thereof, according to an embodiment of the present invention;

FIG. 11 is a perspective front/side view of an electrostatic loudspeaker system that includes an electrostatic driver, a partially baffled dynamic driver and a baffled dynamic subwoofer, according to an embodiment of the present invention;

FIG. 12 is a perspective back/side view of the electrostatic loudspeaker system of FIG. 11;

FIG. 13 is an exploded perspective front/side view of side, top and back panels of the subwoofer of the electrostatic loudspeaker system of FIG. 11;

FIG. 14 is a bottom/side perspective view of the subwoofer enclosure of the electrostatic loudspeaker system of FIG. 11, less a bottom panel;

FIG. 15 is a front/side perspective view of the subwoofer enclosure of FIG. 14, less the bottom panel;

FIG. 16 is a back/side perspective view of the electrostatic loudspeaker system of FIG. 11, with the subwoofer enclosure and other components removed for clarity;

FIG. 17 is a back/side perspective view of the electrostatic loudspeaker system of FIG. 11, with the subwoofer enclosure in place and with a partial baffle in place around the partially baffled dynamic driver, but with a control and connections panel removed;

FIG. 18 is a back/side perspective view of the electrostatic loudspeaker system of FIG. 17, with the control and connections panel installed;

FIG. 19 is a close up perspective view of the control and connections panel of FIGS. 17 and 18;

FIG. 20 is an exploded back/side perspective view of the electrostatic loudspeaker system of FIG. 17 showing a front grill cloth and a rear grill cloth that will be installed on the ESL element and a grill cloth that will be installed on the partially baffled dynamic driver;

FIG. 21 is a schematic front view illustration of an electrostatic loudspeaker system having two different-sized electrostatic loudspeaker elements, each for handling a separate range of audio frequencies, according to an embodiment of the present invention; and

FIG. 22 is a schematic front view illustration of an electrostatic loudspeaker system having three different-sized electrostatic loudspeaker elements, each for handling a separate range of audio frequencies, according to an embodiment of the present invention.

### DETAILED DESCRIPTION OF SPECIFIC EMBODIMENTS

### Definitions

As used in this description and the accompanying claims, the following terms shall have the meanings indicated below, unless the context otherwise requires.

The term “non-woven fiber” includes fuzzy materials, such as planar materials that have members (“hair”) projecting from the surface of the planar material.

### Damping Screen

Harmonic distortion in an acoustic signal produced by an ESL can be caused by resonance of the diaphragm and/or other components, the diaphragm striking the inside of a stator, variations in component dimensions or construction errors that are, although within tolerance, nevertheless real, and other factors. We have discovered that placing a fine mesh or perforated material (collectively referred to as a “damping screen”) on the outside of the rear-facing stator (or both stators) dramatically improves the frequency transfer function (response curve) of an ESL. Surprisingly, a damping screen flattens the frequency transfer function of the resulting ESL system. That is, the damping screen reduces frequency peaks, such as peaks related to resonances of the diaphragm, without significantly reducing other portions of the frequency transfer function. The damping screen also reduces harmonic distortion caused by other factors. The damping screen does not cause the acoustic signal to be attenuated uniformly across all audio frequencies. However, the amount by which the distortion is reduced is surprising.

The damping screen should be disposed a distance much less than one wavelength of the expected audible sound away from the diaphragm. This distance should be easily met, given the relatively close spacing, typically about 2.4 mm, between the diaphragm and the stator.

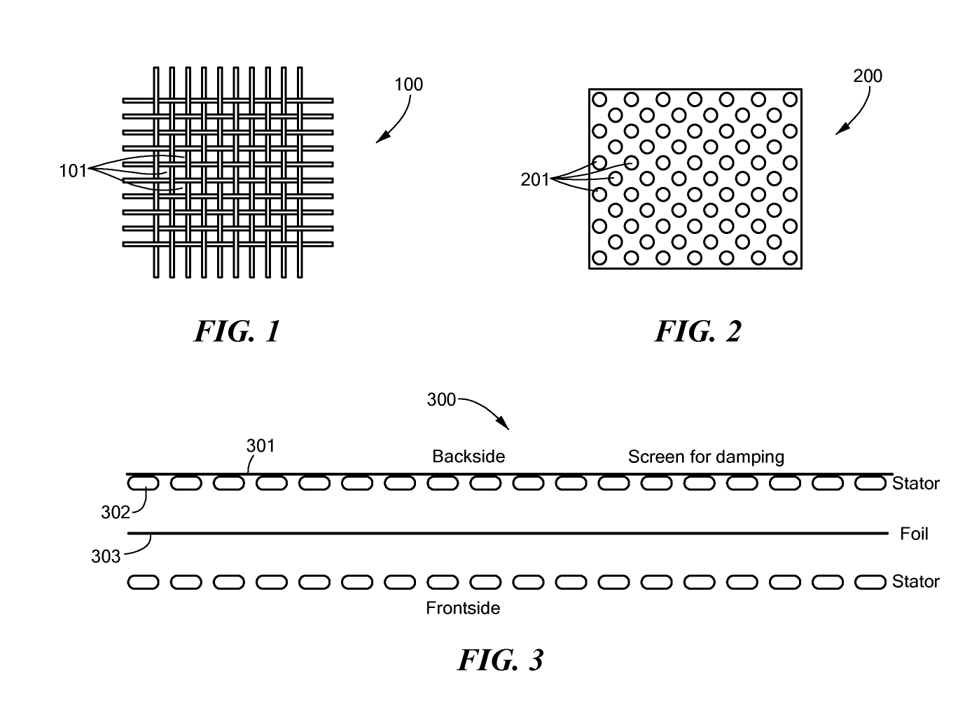

As noted, the damping screen can be a fine mesh, such as a woven material, or a perforated sheet, such as metal or plastic. The threads of a woven material may be plastic or metal, electrically conductive or non-conductive. Similarly, a perforated sheet damping screen may be electrically conductive or non-conductive. FIG. 1 is a schematic illustration of a portion of a woven damping screen 100, and FIG. 2 is a schematic illustration of a portion of a perforated damping screen 200. In either case, the damping screen defines openings therethrough, exemplified by openings 101 and 201. The openness, i.e., the ratio of the total area of the openings to the area of the damping screen, is important. In a woven damping screen, the openness is determined by the weave density of the threads that make up the damping screen, as well as the diameter of the threads. Preferably, the threads have round cross-sectional shapes, so as to produce few, if any, sharp edges. Similarly, the edges of the holes in a perforated damping screen should be rounded or chamfered to avoid sharp edges.

The openness of a damping screen should be selected to correspond to expected frequencies produced by the ESL. Relatively larger values of openness should be used for low frequencies, whereas relatively smaller values of openness should be used for high frequencies. In one embodiment, a damping screen having about 22% openness is used for an ESL that handles audio frequencies above about 200 Hz. (Lower frequencies may be handled by a separate subwoofer, such as a conventional dynamic loudspeaker mounted in an enclosure.) In another embodiment that includes two or more separate diaphragms, or a single diaphragm that is partitioned into two or more sections, such that each diaphragm or section handles a different frequency range, a damping screen having about 33% openness is used on the back stator (or portion thereof) that overlays the diaphragm or section that handles frequencies in a range of about 70-250 Hz, and a damping screen having about 22% openness is used on the back stator (or portion thereof) that overlays the diaphragm or section that handles frequencies above about 250 Hz. In general, we have found that damping screens having opennesses of about 15-50% may be used, and values of openness may be empirically determined based on desired results, based on the considerations and teachings above.

We have found that conventional silk screen material, i.e., material used for silk screen printing, having a thread density of about 54 threads per cm and a thread diameter of about 64 μm, can be used to make an acceptable damping screen for audio frequencies above about 50 Hz. Scientific and industrial filter sheets are also suitable. Silk screen material is typically manufactured with tight tolerances on weave density and thread diameter and, therefore, provide damping screens with predicable and accurately-specified openness values. A suitable polyester-based silk screen material is available from DDS Bruma B. V., De Posthoorstraast 8, 5048 AS Tilburg, The Netherlands, under part number JMC 54.64. DDS Bruma distributes materials produced by Japanese Mesh Corporation (JMC Monoplan). Another suitable supplier is Sefar Printing Solutions, Inc., Lumberton, N.J. 08048.

The damping screen may be glued directly to the back of a stator with a suitable adhesive. Optionally or alternatively, the damping screen may be applied to the inside surface of the stator. (“Directly” here includes the possibility that the stator is painted or otherwise coated and the damping screen is attached to the paint or other coating.) It is important that the damping screen be adhered to the stator over at least most of the non-open area of the damping screen, otherwise the damping screen may “puff out” with sound waves emanating from the stator. Movement of the damping screen in this manner would defeat or reduce the effectiveness of the damping screen, at least for frequencies involved in moving the damping screen.

FIG. 3 is a cross-sectional schematic illustration of an electrostatic loudspeaker 300 having a damping screen 301 adhered directly on a back side stator 302 thereof. The damping screen 301 appears to create an acoustic resistance to sound waves or air travel, which causes a back pressure on the diaphragm 303, thereby reducing movement of the diaphragm 303 and attenuating the acoustic signal. However, this effectiveness of this damping seems to be non-linear with amplitude of the acoustic signal. Therefore, peaks in the frequency transfer function of the resulting ESL system are reduced more than other portions of the transfer function, thereby flattening the transfer function. The effect is similar to an electric series LC (inductor-capacitor) circuit, which has a low impedance (theoretically zero) at the resonance frequency of the circuit. By putting a resistor in series with the LC circuit (analogous to damping), one can totally eliminate this zero effect, and by varying this resistance one can tailor this peak according to requirements.

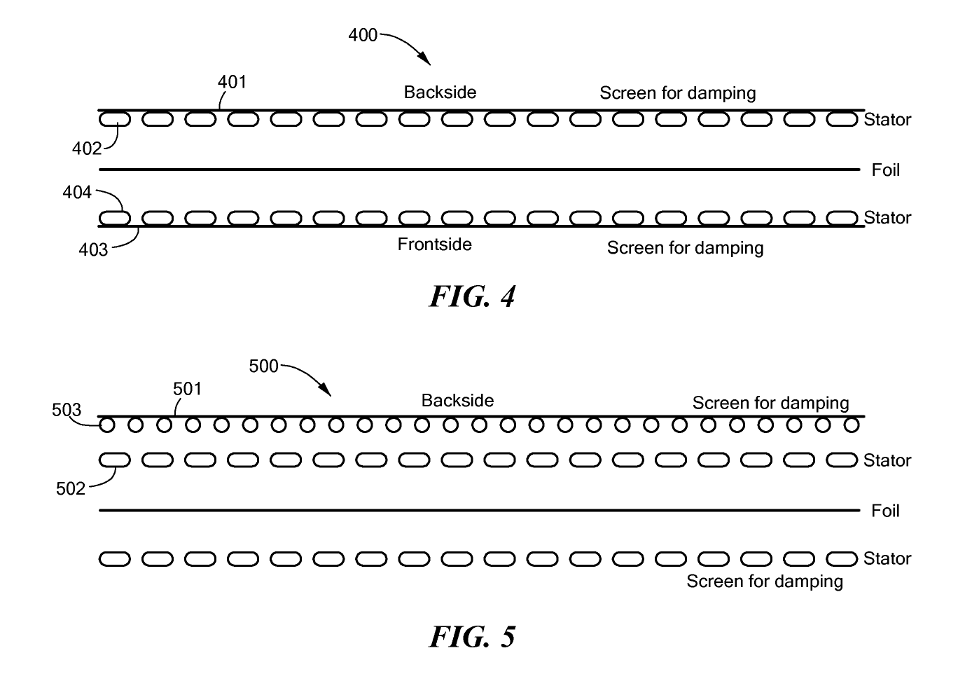

FIG. 4 is a cross-sectional schematic illustration of an electrostatic loudspeaker 400 having a first damping screen 401 directly on a back side stator 402 thereof and a second damping screen 403 directly on a front side stator 404 thereof, according to another embodiment of the present invention. As noted, the damping screens 401 and 403 may be adhered to the stator(s) 402 and 404 by glue. The damping screen 401 on the front side stator 402 can have the same or different characteristics (such as openness) as the damping screen 403 on the back side stator 404. For example, the back side damping screen 404 can provide more damping (using a less open damping screen) than the front side damping screen 401, so as to influence the direct sound field (towards the listener) less than the indirect sound field.

As noted, in some configurations, ESLs operate with high voltages on the stators. If the damping screen is made of a non-conductive material, such as a suitable plastic, the damping screen may provide sufficient electrical insulation to protect a user from electric shock, should the user touch the damping screen. We have found that applying the damping screen to only the rear-facing stator produces more open and transparent sound from the front of the ESL than applying damping screens to both the front- and rear-facing stators.

FIG. 5 is a cross-sectional schematic illustration of an electrostatic loudspeaker 500 having a damping screen 501 spaced apart from a back side stator 502 thereof, according to another embodiment of the present invention. In this embodiment, a separate rigid perforated, slotted or otherwise open plate 503 is disposed a distance from the back stator 502, and the damping screen 501 is adhered to the separate plate 503. The separate plate 503 may be attached directly or indirectly to the stator 502, so as to maintain a desired separation between the plate 503 and the stator 502. If a high voltage is present on the stator 502 and the separate plate 503 is attached to the stator, the separate plate 503 may be attached via a non-conductive spacer. Spacing the damping screen 501 from the stator 502 may introduce an undesirable phase delay in the back pressure caused by the damping screen 501. However, a spaced apart damping screen 501 or a separate plate 503 may provide more electric shock protection, particularly if separate damping screens and plates are disposed near each of the two stators (not shown).

If an electrically conductive damping screen or a conductive separate plate is used on a traditional, i.e., non-invertedly driven ESL, the damping screen or the separate plate, the adjacent stator and the glue, air or other dielectric therebetween form a capacitor, which may introduce an undesirable parasitic capacitance into the ESL system. However, in an invertedly driven ESL, the audio signal is not present on the stator; therefore any capacitance introduced by a conductive damping screen or separate plate should not be of concern.

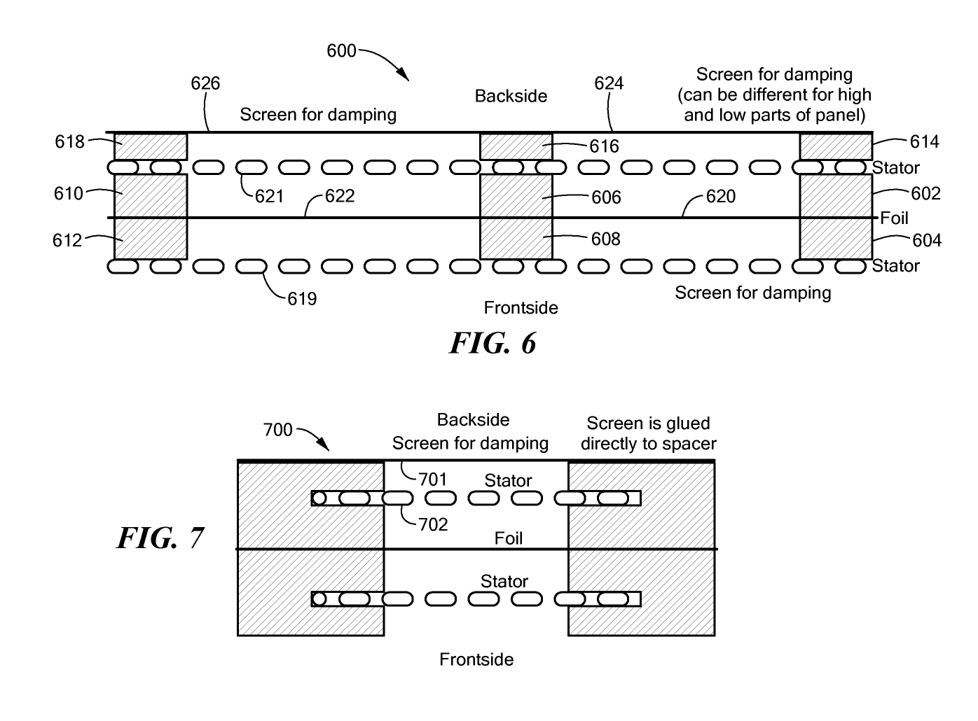

FIG. 6 is a cross-sectional schematic illustration of an electrostatic loudspeaker 600 having a damping screen spaced apart from a back side stator thereof, according to another embodiment of the present invention. In this embodiment, spacers 602, 604, 606, 608, 610 and 612 are disposed between the diaphragm 620/622 and the stators 619 and 621. The specific embodiment shown in FIG. 6 includes six such spacers, three on each side of the diaphragm 620/622. However, other numbers of spacers may be used. Similar spacers 614, 616 and 618 may be used on the outside of the stator 621 to attach the damping screen 624/626 to the stator. In one embodiment, the spacers 614-618 (and possibly additional spacers, not visible in the view provided in FIG. 6) form a frame outlining the stator 621, and the damping screen 624/626 is stretched and then attached to the frame, such as with glue or by clamping the damping screen material between another member of the frame (not shown).

The embodiment shown in FIG. 6 includes two separate diaphragms 620 and 622 or a single diaphragm that is partitioned into two sections 620 and 622 by the middle spacers 606 and 608. Each of the two diaphragms or sections 620 and 622 may be configured or optimized for a different range of frequencies. In this case, damping screens 624 and 626 having two different openness values may be used, one 624 for the upper diaphragm 620 and the other 626 for the lower diaphragm 622.

FIG. 7 is a cross-sectional schematic illustration of an electrostatic loudspeaker 700 having a damping screen 701 spaced apart from a back side stator 702 thereof, according to yet another embodiment of the present invention.

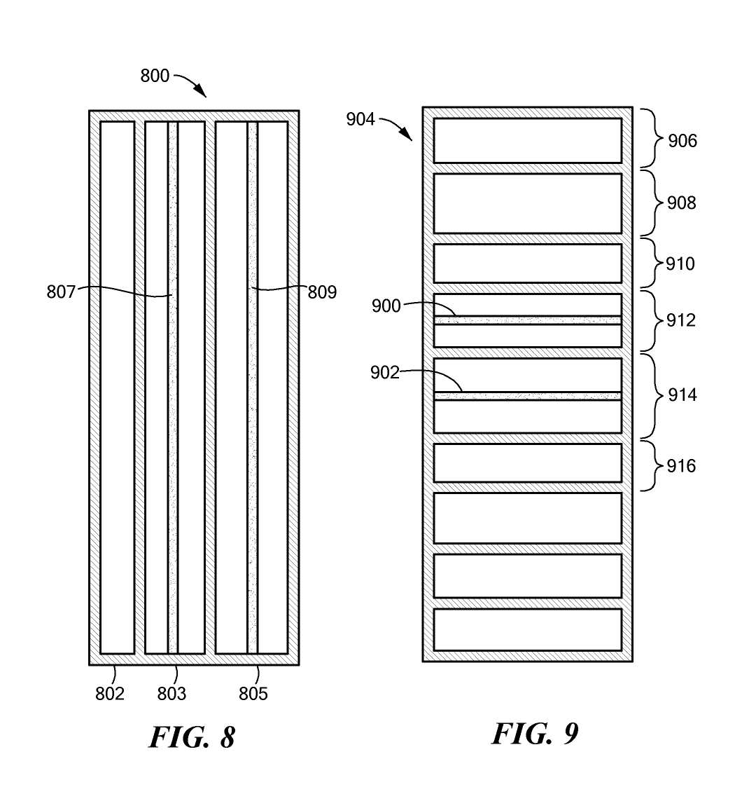

We have found that strategic placement of damping tape over portions of the damping screens further improves the frequency transfer function. In addition, we have found that the damping tape forestalls contact between the diaphragm and the stators, as the input audio signal is increased, thereby increasing the maximum sound output before the diaphragm touches the stators. This effect is strongest at the lowest frequencies. Damping tape adhered to portions of the damping screens increases the acoustic resistance of these portions of the damping screens. We have found that applying damping tape to about 15% of the area of the damping screen and located over the area of greatest excursion of the diaphragm (typically the center of the diaphragm), i.e., such that the damping tape is aligned with the longest dimension of the diaphragm, produces the best results. Two embodiments that exemplify this treatment are shown in FIGS. 8 and 9, respectively. The damping tape may be applied to only the largest one or more electrostatic elements (if more than one ESL element is combined into an ESL speaker system) or to only the largest one or more sections of an ESL element (if the ESL element is partitioned into sections, such as described above, with reference to FIG. 6).

FIG. 8 is a schematic diagram front view of an electrostatic loudspeaker 800 that has three diaphragms 802, 803 and 805 (or a single diaphragm partitioned into three sections 802-805 by spacers). Each of the three diaphragms or sections 802-805 may be a different size. The ESL 800 is fed, such that the smallest diaphragm 802 handles high frequencies, such as above about 250 Hz, the middle-sized diaphragm 803 handles middle frequencies, such as in a range of about 70-250 Hz, and the largest diaphragm 805 handles low frequencies, such as below about 70 Hz. Damping screens may be attached to the stator over one or more of the diaphragms or sections 802-805. Assume that damping screen is attached to the stator over the two larger sections 803 and 805. We have found that attaching damping tape over the middle sections 807 and 809 of the damping screens produces good results.

FIG. 9 is a schematic illustration showing placement of damping tape over portions 900 and 902 of damping screens of an electrostatic loudspeaker 904 having more than three diaphragms (or a single diaphragm partitioned into more than three sections), exemplified by diaphragms or sections 906, 908, 910, 912, 914 and 916.

Our experiments indicate that without damping screens, diaphragm and other resonances and other distortions can be up to about +15 db in severe cases. On the other hand, our experiments indicate that proper application of damping screens and damping tape, as described above, can reduce distortion peaks up to about 10 or 20 db and sometimes more. In addition, such reductions in distortion permit operating ESLs at higher sound pressure levels (SPLs) than would otherwise be possible, without introducing an unacceptably high level of distortion. Furthermore, in 3-dimensional (3D) sound systems, minimizing phase shifts is important to producing well imaged sound. We have found that application of damping screens and, in some cases, damping tape as described above, reduces phase shift in far-field sound, thereby improving 3D imaging.

### Mechanical Soft Clipping (Diaphragm Excursion Limiter)

Designing an ESL involves several technical tradeoffs, including balancing the maximum excursion distance of the diaphragm at low frequencies against sensitivity of the ESL to audio signals. At low frequencies, large diaphragm excursions may be necessary to generate sufficient loudness. However, the distance between the diaphragm and the stator needs to be relatively small to achieve reasonable sensitivity. (Larger distances require greater drive voltages to generate equivalent forces to move the diaphragm.) Of course, music is typically quite dynamic over time, in terms of signal level and, therefore, diaphragm excursion distance.

As noted, care must be taken in the design and operation of an ESL to prevent the diaphragm from coming too close to, or into contact with, the inside of a stator. Otherwise, electrical arcing (which produces highly undesirable sounds) and clipping of the acoustic signal may result. In addition, the diaphragm striking the inside surface of the stator produces a sound, inasmuch as the diaphragm act like a taut drum head that is struck by a solid object. Furthermore, an undesirable loss of charges from the conductive portion of the diaphragm to the stator occurs, thereby leaving an unevenly charged diaphragm, at least until the charges are replaced by the high-voltage power supply. In case of inverted drive, the charge on the diaphragm is not held constant, but the voltage remains constant. Small differences can occur, of course, as the resistance of the diaphragm is not zero, but much smaller than the resistance in normal (non-inverted) drive systems.

We have found that applying a relatively thin layer of soft resilient electrically non-conductive material on the inside of each stator practically eliminates the risk of electrical contact between the diaphragm and the stator under normal circumstances and softens the impact of the diaphragm, significantly reducing distortion that would otherwise result from such impact. We call this layer a mechanical “soft clipping” layer. Although the diaphragm may be driven into contact with the soft clipping layer, the diaphragm does not suddenly stop moving, as it would if it were to contact the hard inside surface of the stator. Instead, the resilience of the soft clipping layer relatively slowly decelerates and stops the diaphragm. Once the diaphragm is driven away from the stator, the soft clipping layer rebounds, and it is available to repeat its function, if and when necessary, such as during the next cycle of the audio signal driving the diaphragm.

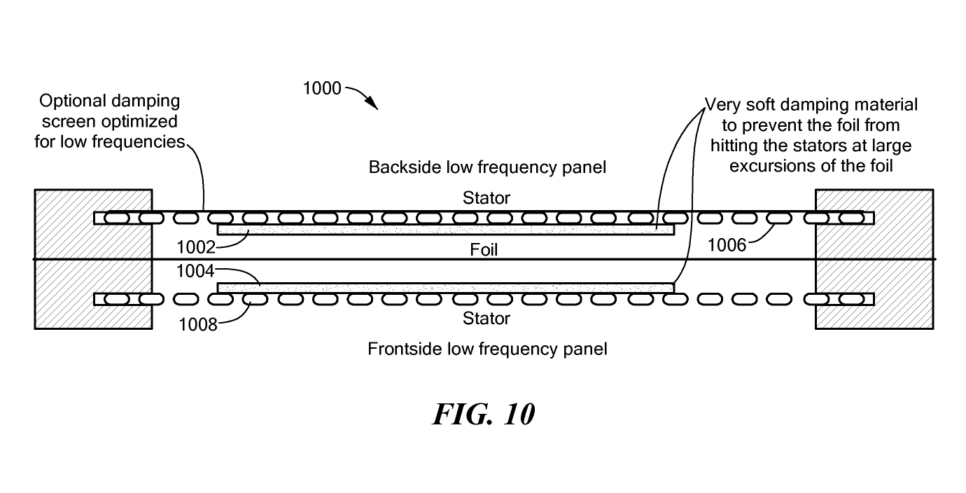

FIG. 10 is a cross-sectional schematic illustration of an electrostatic loudspeaker 1000 having soft clipping layers 1002 and 1004 on inside surfaces of the stators 1006 and 1008 thereof. In one embodiment, each soft clipping layer 1002 and 1004 is about 0.3-0.5 mm thick. We have found that rubber, rubber-like, natural or synthetic latex, soft foam, hairy fabric, foamed or unfoamed neoprene and similar materials are suitable. However, a material, such as an open-celled foam, that does not significantly dampen the sound produced by the diaphragm should be used. A material that exhibits a progressively larger Young's modulus as the material is compressed is preferred. Such a material may be made of several layers of different materials, each having a progressively larger Young's modulus, and disposing the layered material on the inside of the stator such that the layer having the smallest Young's modulus faces the diaphragm.

The soft clipping layer may be glued to the stator. In some embodiments, only portions of the inside of the stator are covered with the soft clipping layer, to reduce the amount sound dampening caused by the layer. In one embodiment, the soft clipping layer is applied to the portions of the stators that correspond to portions of the diaphragm that travel the furthest, such as where the damping tape is applied. The damping introduced by the soft clipping layer can be partially or completely compensated by reducing the dampening of the damping screen and/or tape in corresponding areas, if damping screen or damping tape is used. In other embodiments, the entire inside surface area of the stator is covered with the soft clipping layer.

### Nanofiber-Based Conductive Diaphragm Coating

The fidelity of the acoustic signal depends in part on how faithfully the diaphragm responds to the electrical audio signal, which is influenced by the mass of the diaphragm, more massive diaphragms requiring more electrostatic force to produce equivalent amounts of acceleration (F=ma). Therefore, less massive diaphragms can provide advantages, in terms of sensitivity and fidelity.

We have found that conductive nanofiber-based conductive layers can be applied to diaphragms, thereby significantly reducing the thickness of these layers over prior art conductive layers. A carbon nanotube product, such as Nanocyl™ 7000 thin multi-wall carbon nanotubes, available from Nanocyl S.A., Rue do l'Essor 4, B-5060 Sambreville, Belgium, when suspended in a suitable vehicle, such as a water-based vehicle, and blended with a suitable binder, such as a polymer binder, selected for adhesion to the diaphragm material, forms a suitable ink for printing the conductive layers on the diaphragm. Advantageously, this ink can be applied at lower temperatures than conventional conductive coatings, thus additives in the ink and material in the underlying diaphragm substrate are more stable over time. Once the conductive ink has been printed on the diaphragm, it is left to dry (i.e., to allow the vehicle to evaporate) and cure in an oven at about 100° C. or less for about 2-5 minutes Lower temperatures may require longer drying times, depending on the relative humidity of the ambient air. This drying/curing temperature is lower than for conventional conductive coatings, which also enhances stability over time. Higher drying/curing temperatures may be used, within published limits of the nanofiber-based material and other components of the ink; however, long-term stability of the materials may be negatively affected.

The nanotubes are conductive, yet only about 9.5 nm in diameter and about 1.5 μm long. Thus, a suitable conductive layer that is about 2 μm thick may be produced (after drying and curing). The dried cured conductive layer contains about 1-4% carbon nanotubes. This conductive layer is significantly less massive than conventional conductive layers on diaphragms, thereby yielding a much less massive, and therefore more sensitive, diaphragm. Furthermore, since the conductive layer is less massive than conventional conductive layers, thinner, and therefore less massive, substrates than in conventional diaphragms may be used, further increasing the sensitivity of the diaphragms. The diaphragm may be made of polyethylene terephthalate (PET), polyethylene naphthalate (PEN) or any other suitable material.

In some embodiments, the cured conductive layer has a surface electrical resistivity of about 50-100 kilohms per square.

Optionally, conformal protective layer of material selected for compatibility and adherence to the cured conductive layer may be applied over the conductive layer to protect the conductive layer.

### Dipole-Dipole-Monopole Driver Combination

As noted, most ESLs do not have adequate low-frequency response, and combining ESLs with dynamic subwoofers produces less than ideal results, particularly in the transition frequencies between the two types of drivers. ESL elements are dipole drivers, in that they radiate from both the front and back stators. On the other hand, baffled subwoofers are monopole drivers, in that sound emanates from only a single port and essentially in a single direction. Thus, even if audio signals are divided appropriately and smoothly, according to a well-selected cross-over frequency, between an ESL and a baffled subwoofer, the two radiator modes produces sounds with different characteristics, and this difference yields less than desirable results.

We have found that constructing an ESL system that includes an ESL element, an unbaffled or partially baffled dynamic (cone) driver and a baffled subwoofer, all essentially co-planar, overcomes this problem. The unbaffled or partially baffled dynamic driver produces sound having characteristics that are between that of a dipole driver and a monopole driver. Thus, if high frequencies (such as above about 250 Hz) are handled by the ESL element, a middle range of frequencies (such as about 70-250 Hz) is handled by the unbaffled or partially baffled driver, and low frequencies (such as below about 70 Hz) are handled by a baffled subwoofer, the unbaffled or partially baffled driver provides a smooth transition between the “dipole sound” of the ESL and the “monopole sound” of the subwoofer. This results in a cardioid sound radiation pattern for low frequencies with the advantage of a smooth transition of radiation patterns at the transition frequencies. Advantageously, the cardioid radiation pattern is less sensitive to placement of the speaker system for good sound reproduction.

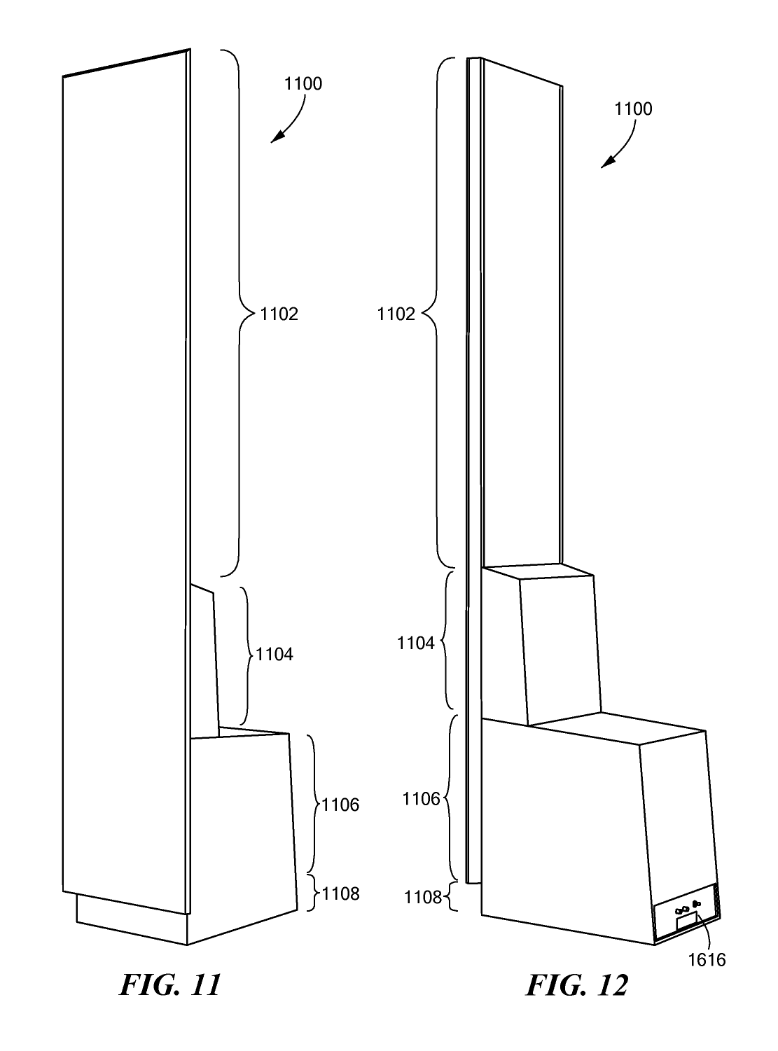

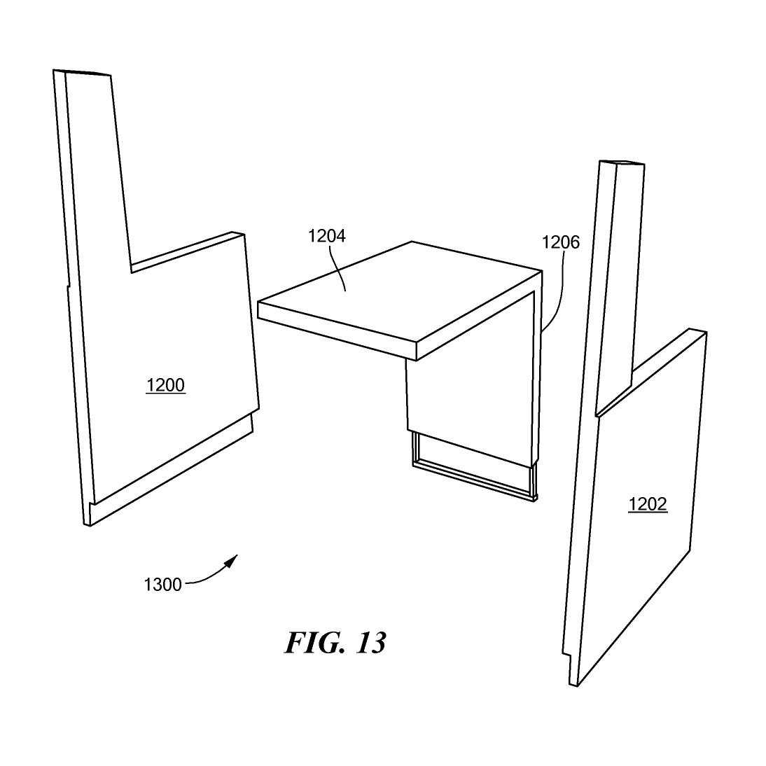

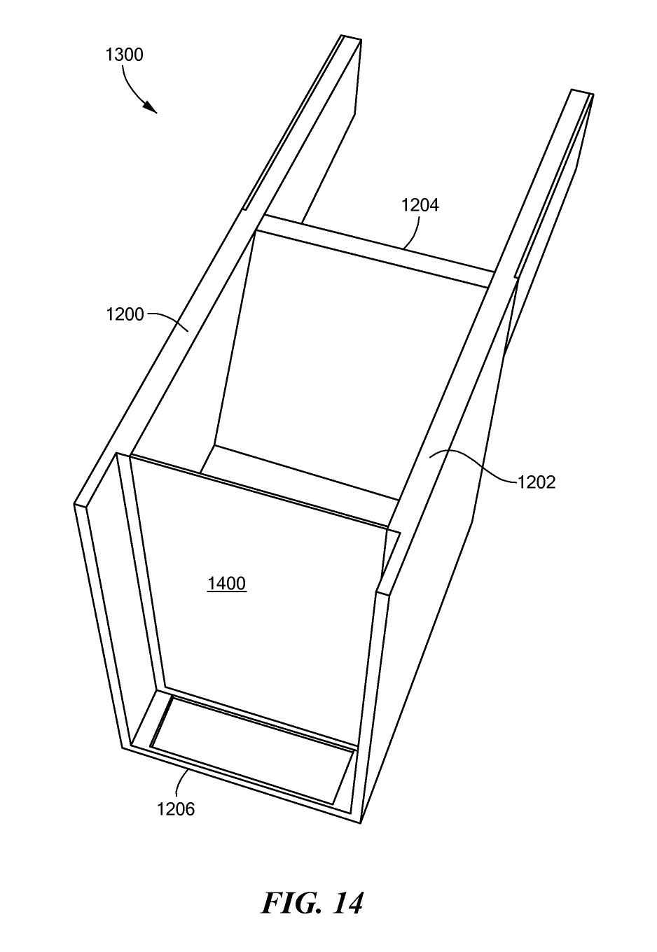

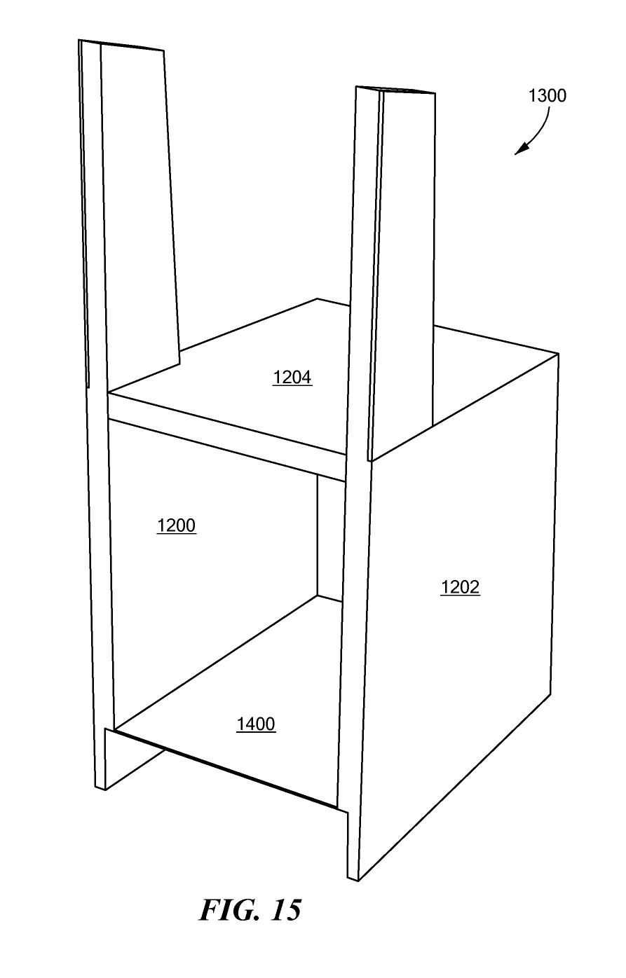

FIGS. 11-20 schematically illustrate an embodiment of an ESL system that includes an ESL element, a partially baffled dynamic cone driver and a baffled subwoofer, as described above. FIG. 11 is a perspective front/side view of an electrostatic loudspeaker system 1100 that includes an electrostatic driver portion 1102, a partially baffled dynamic driver portion 1104, a baffled dynamic subwoofer portion 1106 and an electronics portion 1108, according to an embodiment of the present invention. FIG. 12 is a perspective back/side view of the electrostatic loudspeaker system of FIG. 11. FIG. 13 is an exploded perspective front/side view of side 1200 and 1202 panels, top 1204 and back 1206 panels of a subwoofer enclosure 1300 of the electrostatic loudspeaker system 1100. FIG. 14 is a bottom/side perspective view of the subwoofer enclosure 1300 of the electrostatic loudspeaker system 1100, less a bottom panel for clarity. FIG. 15 is a front/side perspective view of the subwoofer enclosure 1300 of FIG. 14, less the bottom panel.

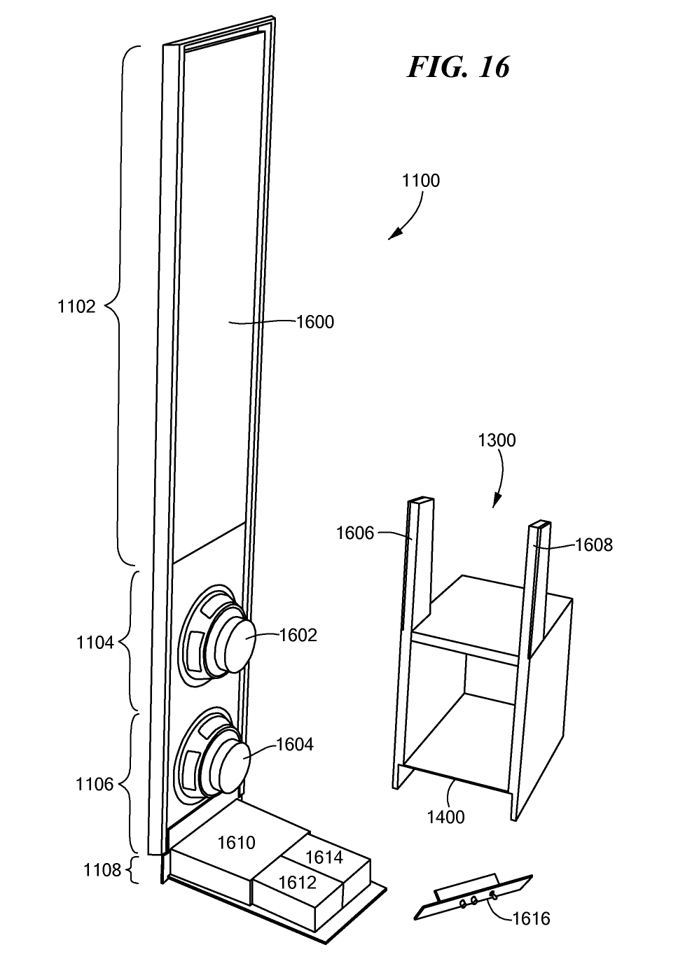

FIG. 16 is a back/side perspective view of the electrostatic loudspeaker system 1100, with the subwoofer enclosure 1300 and other components removed for clarity. An ESL panel 1600 and two dynamic loudspeakers 1602 and 1604 are mounted so as to be essentially co-planar. The dynamic loudspeaker 1602 that handles middle range of frequencies is unbaffled or partially baffled. Optionally, “wings” 1606 and 1608 that extend from the subwoofer enclosure 1300 may be used to partially baffle the midrange dynamic loudspeaker 1602. A panel 1400 (best seen in FIG. 14) in the subwoofer enclosure 1300 provides a bottom wall of the subwoofer enclosure. Thus, the subwoofer dynamic loudspeaker 1604 is fully enclosed.

A high-voltage power supply 1610 and other drive and cross-over circuits 1612 and 1614 are coupled to the ESL panel 1600 and the two dynamic loudspeakers 1602 and 1604. A control and connections panel 1616 (also well shown in FIG. 12) provides electrical connectors between the electronics 1612 and 1614 and an external amplifier (not shown) and (optionally) user controls, such as gain or level controls for the respective frequency ranges handled by the ESL element 1600, the unbaffled or partially baffled dynamic loudspeaker 1602 and the fully enclosed subwoofer dynamic loudspeaker 1604.

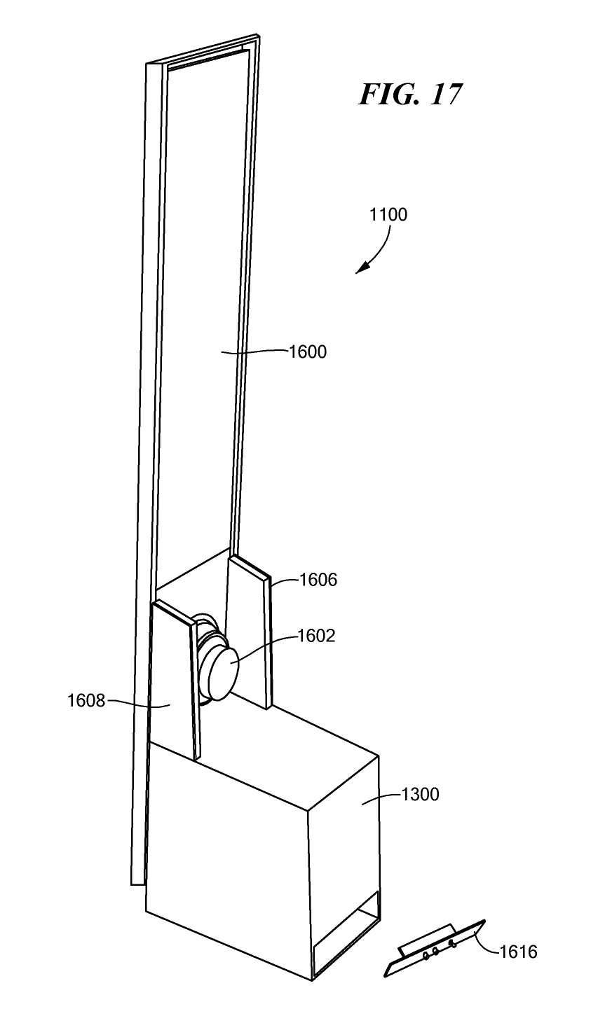

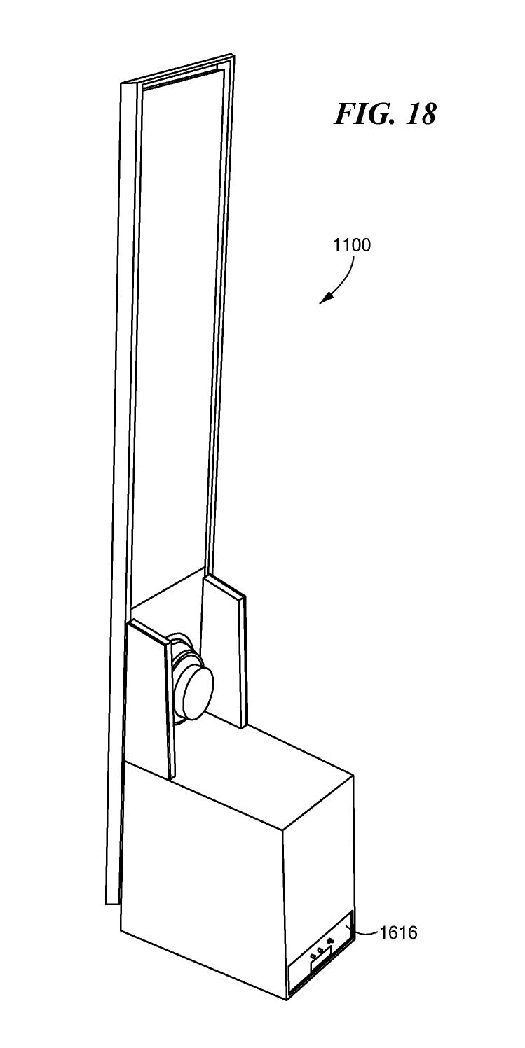

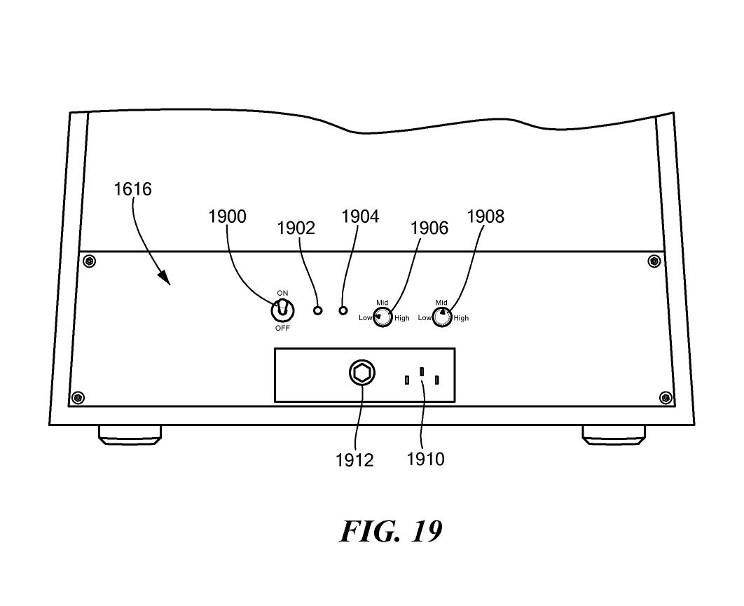

FIG. 17 is a back/side perspective view of the electrostatic loudspeaker system 1100, with the subwoofer enclosure 1300 in place and with the partial baffle 1606 and 1608 in place around the partially baffled dynamic driver 1602, but with a control and connections panel 1616 removed. FIG. 18 is a back/side perspective view of the electrostatic loudspeaker system of FIG. 17, with the control and connections panel installed. FIG. 19 is a close up perspective view of the control and connections panel 1616 of FIGS. 17 and 18. The control and connections panel 1616 may include a power switch 1900, indicators 1902 and 1904, and level controls 1906 and 1908 for the two dynamic loudspeakers 1602 and 1604 (respectively), a power receptacle 1910 and an audio input connector 1912.

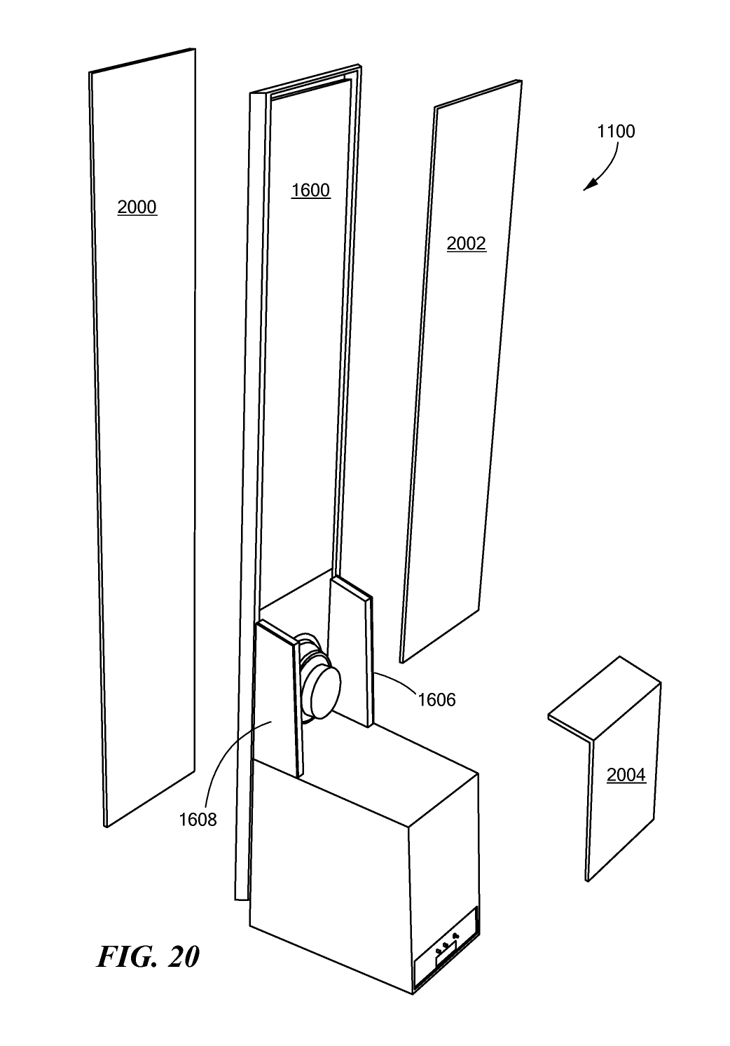

FIG. 20 is an exploded back/side perspective view of the electrostatic loudspeaker system 1100 showing a front grill cloth 2000 and a rear grill cloth 2002 that will be installed on the ESL element 1600 and a grill cloth 2004 that will be installed on the partially baffled dynamic driver baffles 1606 and 1608.

### Separate High- and Low-Frequency ESL Elements with Inverted Drive

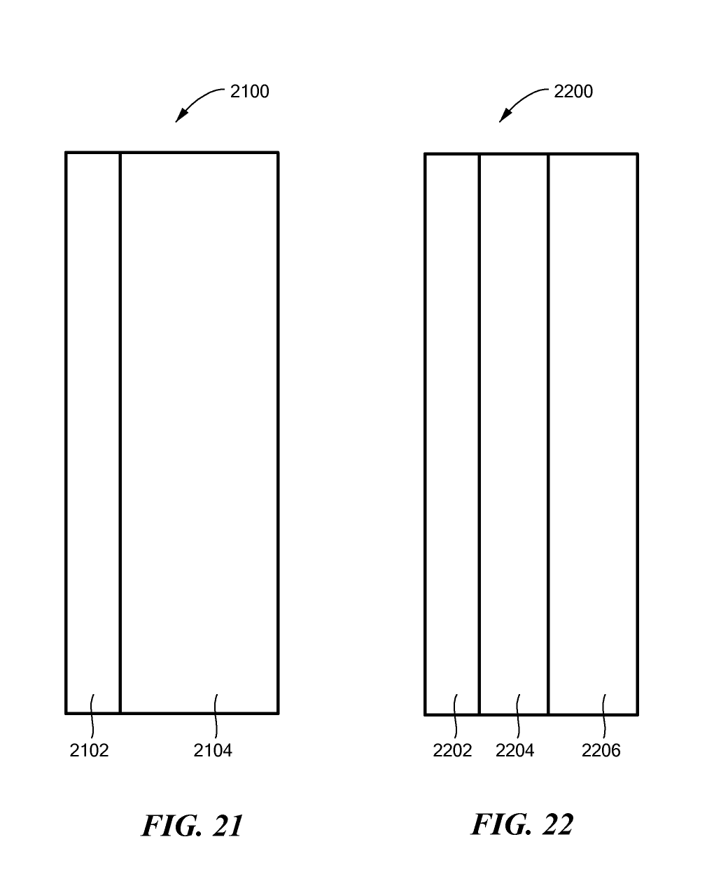

Some embodiments include two or more ESL elements, each handling a discrete or somewhat overlapping range of audio frequencies, where each ESL element is separately invertedly driven, and the ESL panels are mounted so as to be substantially co-planar. FIG. 21 illustrates one such embodiment 2100 having two ESL elements 2102 and 2104, and FIG. 22 illustrates another such embodiment 2200 having three ESL elements 2202, 2204 and 2206.

Each ESL element 2102-2104 or 2202-2206 is connected to its own high-voltage supply (not shown), so the gains for the various frequency ranges need not be equal and can be separately adjusted or optimized. Furthermore, because each ESL element 2102-2104 or 2202-2206 is coupled via a dedicated transformer, the impedance match between the amplifier's output and the ESL element can be optimized. For example, an ESL element 2102 or 2202 that handles high frequencies, such as above about 250 Hz, may be smaller than the other ESL element(s) 2104 or 2204-2206. A small ESL element 2102 or 2202 is less directional than a large ESL element 2104 or 2204-2206. Thus, the high-frequency ESL element 2102 or 2202 exhibits broader sound dispersion, and positioning the element is less critical to achieving proper sound imaging. In addition, a smaller ESL element 2102 or 2202 exhibits less capacitance than a large ESL element 2104 or 2204-2206, thus a lower winding ratio in the transformer is required.

All the above-described embodiments may be used with conventional (normal) or inverted drive systems. Furthermore, features or structures of any of the above-described embodiments may be combined with features or structures of one or more other of the above-described embodiments.

In accordance with preferred embodiments of the present invention, various aspects of an electrostatic loudspeaker system are disclosed, including: a damping screen applied to the outside surface of one or both stators, with and without damping tape; a mechanical soft clip layer applied to the inside surfaces of stators; a nanofiber-based conductive diaphragm coating, ink and process for printing and curing the ink; and a hybrid dipole ESL-partially baffled dynamic dipole-baffled dynamic monopole speaker system. While specific values chosen for some embodiments are recited, it is to be understood that, within the scope of the invention, the values of all of parameters may vary over wide ranges to suit different applications.

While the invention is described through the above-described exemplary embodiments, it will be understood by those of ordinary skill in the art that modifications to, and variations of, the illustrated embodiments may be made without departing from the inventive concepts disclosed herein. Furthermore, disclosed aspects, or portions of these aspects, may be combined in ways not listed above. Accordingly, the invention should not be viewed as being limited to the disclosed embodiments.

What is claimed is:

1. An improved electrostatic speaker of the type having a pair of stators and a diaphragm disposed between the stators, the speaker rendering, into an acoustic output, an electrical audio input coupled to the speaker, wherein the improvement comprises a damping screen placed adjacent to an outside surface of least one of the stators, configured so that the damping screen reduces distortion of the acoustic output rendered by the diaphragm, such distortion including effects of resonance of the diaphragm.

2. An electrostatic speaker according to claim 1, wherein the damping screen comprises a fabric selected to provide effective damping of resonance of the diaphragm at a fundamental frequency.

3. An electrostatic speaker according to claim 1, further comprising a damping tape placed on a central portion of the damping screen, the damping tape providing further damping of the diaphragm.

4. An electrostatic speaker according to claim 3, wherein the area of the damping tape is about 15% of the area of the diaphragm.

5. An electrostatic speaker according to claim 3, wherein the longest dimension of damping tape is aligned with the longest dimension of the diaphragm.

6. An electrostatic speaker according to claim 3, wherein the electrostatic speaker includes a plurality of electrostatic speaker elements and the damping tape is placed over fewer than all of the electrostatic speaker elements.

7. An electrostatic speaker according to claim 3, wherein the electrostatic speaker is partitioned into a plurality of sections and the damping tape is placed over fewer than all of the sections.

8. A speaker according to claim 2, wherein the fabric is woven from threads.

9. A speaker according to claim 2, wherein the fabric is a perforated sheet of material.

10. A speaker according to claim 8, wherein the threads are of plastic.

11. A speaker according to claim 8, wherein the threads are polyester.

12. A speaker according to claim 11, wherein the threads are spaced at a density of about 54 threads per cm and have a diameter of about 64 microns.

13. A speaker according to claim 3, wherein the threads are of metal.

14. A speaker according to claim 2, wherein fabric has a porosity of between 10 and 50%.

15. A speaker according to claim 2, wherein the fabric has a porosity of between 15% and 40%.

16. A speaker according to claim 2, wherein the fabric has a porosity between 20% and 35%.

17. An electrostatic speaker according to claim 1, wherein the screen is affixed by glue to the outside surface of the at least one of the stators.

18. An improved electrostatic speaker of the type having a pair of stators and a diaphragm disposed between the stators, wherein the improvement comprises a resilient excursion limiter placed adjacent an inside surface of at least one of the stators and configured so as to prevent contact of the diaphragm with the at least one of the stators.

19. An electrostatic speaker according to claim 18, wherein the excursion limiter is made of a material selected from the group consisting of non-woven fiber and foam.

20. An electrostatic speaker according to claim 18, wherein the excursion limiter is made of a woven material.

21. An improved electrostatic speaker of the type having a pair of stators and a diaphragm disposed between the stators, the speaker rendering, into an acoustic output, an acoustic signal based on an electrical audio input coupled to the speaker, wherein the improvement comprises a conductive ink layer disposed on the diaphragm, the conductive ink including conductive nanofibers.

22. A speaker system according to claim 21, wherein the conductive ink provides a resistance of between approximately 50 and 100 kilo-ohms per square.

23. A speaker system according to claim 21, wherein the nanofibers include a first dimension that is less than approximately 50 nm.

24. A speaker system according to claim 21, wherein the nanofibers include a first dimension that is approximately 10 nm.

25. A speaker system comprising:
an electrostatic speaker;
a first dynamic speaker; and
a second dynamic speaker;
all such speakers being mounted in an assembly wherein they have front-facing acoustic radiating openings that are approximately co-planar; and wherein:
(i) the first dynamic speaker is enclosed so that substantially all of its acoustic output exits from the enclosure through the speaker's front-facing opening and the first dynamic speaker is powered through a first cross-over network to receive audio input in a sub-woofer range below a first cut-off frequency;
(ii) the second dynamic speaker is mounted so that it provides substantial acoustic output both through the speaker's front-facing opening and through a rear-facing opening and the second dynamic speaker is powered through second cross-over network to receive audio input in a woofer range above the first cut-off frequency and below a second cut-off frequency; and
(iii) the electrostatic speaker is powered through a third cross-over network to receive audio input above the second cut-off frequency.

26. A speaker system according to claim 25, wherein the first cut-off frequency is about 70 Hz and the second cut-off frequency is about 250 Hz.

27. A speaker system according to claim 25, wherein the first and second dynamic speakers are mounted in the assembly such that a radiation pattern of the first dynamic speaker overlaps with a radiation pattern of the second dynamic speaker and the overlap between the first and second dynamic drivers forms a cardioid radiation pattern.

28. An electrostatic loudspeaker system, comprising:
a first electrostatic loudspeaker element having a first pair of stators and a first diaphragm disposed between the first stators, the first diaphragm having a first area, the first electrostatic loudspeaker element configured for coupling to a first inverted electrostatic loudspeaker driver circuit to receive audio signals above a first predetermined cross-over frequency; and
a second electrostatic loudspeaker element having a second pair of stators and a second diaphragm disposed between the second stators, the second diaphragm having a second area greater than the first area of the first diaphragm, the second electrostatic loudspeaker element configured for coupling to a second inverted electrostatic loudspeaker driver circuit, distinct from the first inverted electrostatic loudspeaker driver circuit, to receive audio signals below the first predetermined cross-over frequency;
the first and second electrostatic loudspeaker elements being mounted in an assembly so as to be approximately co-planar with and adjacent each other.

29. An electrostatic loudspeaker system according to claim 28, further comprising:
a third electrostatic loudspeaker element having a third pair of stators and a third diaphragm disposed between the third stators, the third diaphragm having a third area greater than the second area of the second diaphragm, the third electrostatic loudspeaker element configured for coupling to a third inverted electrostatic loudspeaker driver circuit, distinct from the first and second inverted electrostatic loudspeaker driver circuits, to receive audio signals below a second predetermined cross-over frequency lower than the first predetermined cross-over frequency;
the third electrostatic loudspeaker elements being mounted in the assembly so as to be approximately co-planar with the first and second electrostatic loudspeaker elements and adjacent at least one of the first and second electrostatic loudspeaker elements.
